(19) United States
(12) Patent Application Publication
(10) Pub. No.: US 2003/0106638 A1
(43) Pub. Date: Jun. 12, 2003

(54) Manufacturing method of a temperature-controlling plate

(75) Inventors: Kazuya Kuriyama, Hirakata-shi (JP); Toru Kihara, Hirakata-shi (JP); Toshio Yoshimitsu, Hiratsuka-shi (JP)

Correspondence Address: ARMSTRONG,WESTERMAN & HATTORI, LLP, 1725 K STREET, NW, SUITE 1000, WASHINGTON, DC, 20006, US

(73) Assignee: KOMATSU LTD., Tokyo (JP)

(21) Appl. No.: 10/349,076

(22) Filed: Jan. 23, 2003

Related U.S. Application Data
(63) Continuation of application No. 09/748,106, filed on Dec. 27, 2000, now abandoned.

(30) Foreign Application Priority Data
Dec. 28, 1999 (JP) 11-374458

(51) Int. Cl. B32B 31/00

(52) U.S. Cl. 156/278

(57) ABSTRACT

Upon adhering a film heater 3 to the surface of a heat-conducting plate 1 having a plate shape, first, liquid resin, applied to the surface of the heat-conducting plate 1, is dried and set to form an adhesive layer 2 (S1). Next, the film heater 3 and the heat-conducting plate 1 are placed face to face with each other with the adhesive layer 2 interpolated In between (S2). Successively, this is heated to a predetermined temperature, while applying a predetermined pressure thereto so as to bond the film heater 3 and the heat-conducting plate 1 to each other (S3). Thereafter, a coating process is applied to the film heater 3 (S4). That way, the present invention enables to make a temperature-controlling plate thinner and capable of exerting high performances. Moreover, a heat-conducting plate and a film heater are positively bonded to each other with sufficient strength.

### BACKGROUND OF THE INVENTION

1. Field of the Invention

The present invention relates to a manufacturing method of a temperature-controlling plate used for, for example, a temperature-controlling process for a substrate in a manufacturing process of a semiconductor wafer, and more particularly, concerns a manufacturing method of a temperature-controlling plate that is formed through processes in which a film heater constituted by a heat absorbing and radiating section formed on the surface of a resin film is bonded to the surface of a heat-conducting plate having a plate shape.

2. Prior Art

Manufacturing processes of a semiconductor wafer include processes for controlling the temperature of a substrate, such as a baking process for heating the substrate so as to remove a solvent remaining on a photo resist film (photosensitive film) coated on the surface of the substrate and a cooling process for cooling the heated substrate to a room temperature level. For this reason, a substrate temperature controlling device, used in these processes, is provided with a temperature controlling plate constituted by a film heater bonded to the surface of a heat-conducting plate formed by a high-temperature conductive material such as aluminum.

FIG. 4 is a side view that shows the structure of a conventional temperature-controlling plate 21. The temperature-controlling plate 21 is provided with a heat-conducting plate 22 having a plate shape that is formed by a high-temperature conductive material such as aluminum and copper. A heater 23 having a film shape is bonded to the surface of the heat-conducting plate 22 through a sheet-shape adhesive agent (adhesive layer ) 25. The heater 23 is formed by subjecting a stainless film thermally press-bonded onto a resin film to an etching process so as to pattern a predetermined heater circuit. Moreover, on the surface of the heater 23 bonded to the heat-conducting plate 22 is bonded a cover sheet 24 made of resin through a sheet-shape adhesive agent (adhesive layer) 25 that is the same type as described above. Here, the heater 23 and the cover sheet 24, bonded to each other through the sheet-shaped adhesive agent 25 constitutes a film heater 26.

FIG. 5 is a side view that shows a manufacturing method of the temperature-controlling plate 21. The temperature-controlling plate 21 is constituted by the sheet-shaped adhesive agent 25, the heater 23, the sheet-shaped adhesive agent 25 and the cover sheet 24 that are stacked on the heat-conducting plate 22 in this order, and that are heated to a predetermined temperature under a predetermined pressure, so that the respective materials are bonded to each other (see Japanese Patent Application No. 113975/1999 (Hei 11-113975).)

In the conventional manufacturing method as described above, however, the respective members are bonded to each other by using the sheet-shaped adhesive agent 25; and with respect to the sheet-shaped adhesive agent 25, in order to ensure its adhesive property, it is necessary to use those materials having a considerable thickness, for example, a thickness of approximately 25 μm. The resulting disadvantage is that it is difficult to provide a thinner temperature-controlling plate. Moreover, the application of such a thick sheet-shaped adhesive agent 25 causes a reduction in the thermal conductivity in this portion, resulting in adverse effects on the performance of the temperature-controlling plate. Another problem is that the adhesive strength is not sufficient.

### SUMMARY OF THE INVENTION

The present invention has been devised to solve the above-mentioned conventional problem, and its objective is to provide a manufacturing method of a temperature-controlling plate which makes the temperature-controlling plate thinner, allows it to have higher performances, and also makes it possible to positively bond the heat-conducting plate and the film heater to each other with sufficient strength.

In order to solve the above-mentioned problems, a manufacturing method of a temperature-controlling plate in accordance with claim 1, which has an arrangement in which a film heater 3 constituted by a heat absorbing and radiating section 5 formed on a surface of a resin film 4 is bonded to a surface of a heat conducting plate 1 having a plate shape, 1s provided with the steps of: forming an adhesive layer 2 by drying and setting liquid resin that has been applied to the surface of the heat conducting plate 1; placing the film heater 3 and the heat-conducting plate 1 so as to be aligned face to face with each other with the adhesive layer 2 interpolated in between; and heating this to a predetermined temperature while applying a predetermined pressure to this so as to bond the film 3 to the heat-conducting plate 1.

In the manufacturing method of the temperature-controlling plate in accordance with claim 1, since the adhesive layer 2, which is formed by drying and setting the liquid resin, is used, it is possible to improve the adhesive property between the adhesive layer 2 and the heat-conducting plate 1, as compared with the conventional case in which a sheet-shaped adhesive agent is used. Moreover, since the adhesive layer 2 and the resin film 4 of the film heater 3 have similar physical properties to each other, the adhesive layer 2 and the resin film 4 provide a superior adhesive state Therefore it becomes possible to positively bond the heat-conducting plate 1 and the film heater 3 to each other with sufficient strength.

Furthermore, since the liquid resin is less expensive than the sheet-shaped resin (sheet-shaped adhesive agent), it is possible, to manufacture the temperature-controlling plate at low costs. Since the application of the liquid resin makes the adhesive layer 2 thinner than the sheet-shaped adhesive agent, it is possible to make the temperature-controlling plate thinner. Moreover, since the adhesive layer 2 is made thinner than the conventional layer, the thermal conductivity becomes superior correspondingly, thereby allowing the temperature-controlling plate to have higher performances.

Moreover, in the case when the adhesive layer 2 is formed on the film heater 3 side, the film heater is susceptible to wrinkles and warping at the time of drying and setting; however, in the present invention, since the adhesive layer 2 is formed on the surf ace of the heat-conducting plate 1, the film heater 3 is free from wrinkles and warping, thereby making it possible to manufacture a flat temperature-controlling plate.

Moreover, in the manufacturing method of the temperature-controlling plate in accordance with claim 2, the heat absorbing and radiating section 5 of the film heater 3 is formed on the side opposite to the adhesive face of the heat-conducting plate 1 so that the liquid resin is applied, dried and set in a manner so as to coat the heat absorbing and radiating section 5. The manufacturing method in accordance with claim 1 includes not only the case in which the resin film, 4 of the film heater 3 is bonded to the surface of the heat-conducting plate 1, but also the case in which the heat absorbing and radiating section 5 of the film heater 3 is bonded to the heat-conducting plate 1; and in claim 2, the resin film 4 of the film heater 3 is bonded to the surface of the heat-conducting plate 1 in a manner so as to coat the heat absorbing and radiating section 5 placed on the outer surface.

In the manufacturing method of a temperature-controlling plate in accordance with claim 2, since the heat absorbing and radiating section 5 of the film heater 3 is coated so that the heat absorbing and radiating section 5 is protected and heat is uniformly conducted. Moreover, in the case when the surface of the heater is coated with a cover sheet through a sheet-shaped adhesive agent, as in the case of the conventional method, the heater is susceptible to wrinkles and warping at the time of adhesive; however, the above-mentioned coating process in which the liquid resin is applied, dried and set makes it possible to eliminate such problems.

In the manufacturing method of a temperature-controlling plate of claim 3, the resin film 4 of the film heater 3 is a polyimide film, the heat-conducting plate 1 is aluminum, and the liquid resin is liquid polyimide.

The manufacturing method of the temperature-controlling plate in accordance with claim 3 is easily carried out. Moreover, since the adhesive layer 2 composed of liquid polyimide is used, the high-temperature resistance of the adhesive layer 2 is improved. More specifically, the liquid polyimide in this case refers to a thermoplastic polyimide adhesive agent or a thermosetting polyimide adhesive agent. Specific examples of the thermosetting polyimide adhesive agent include Upifine LT and Upivarnish made by Ube Industries, Ltd., and LARC-TRI made by Mitsui Toatsu Chemicals, Inc., etc. Moreover, specific examples of the thermoplastic polyimide adhesive agent include UPA made by Ube Industries, Ltd., etc.

### BRIEF DESCRIPTION OF THE DRAWINGS

FIG. 1 is a drawing that shows an embodiment of a manufacturing method of a temperature-controlling plate in accordance with the present invention.

FIG. 2 is a side view that shows the manufacturing method.

FIG. 3 is a graph that shows the high-temperature strength of an adhesive agent.

FIG. 4 is a side view that shows another structure of a conventional temperature controlling plate.

FIG. 5 is a side view that shows a manufacturing method of a conventional temperature-controlling plate.

### DESCRIPTION OF BEST MODE FOR CARRYING OUT THE INVENTION

Referring to Figures, the following description will discuss specific embodiments of the present invention.

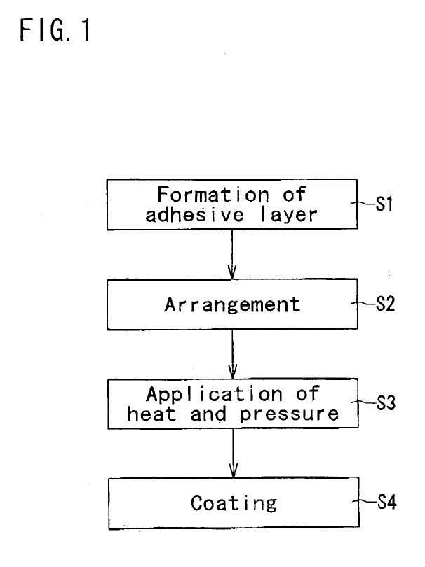

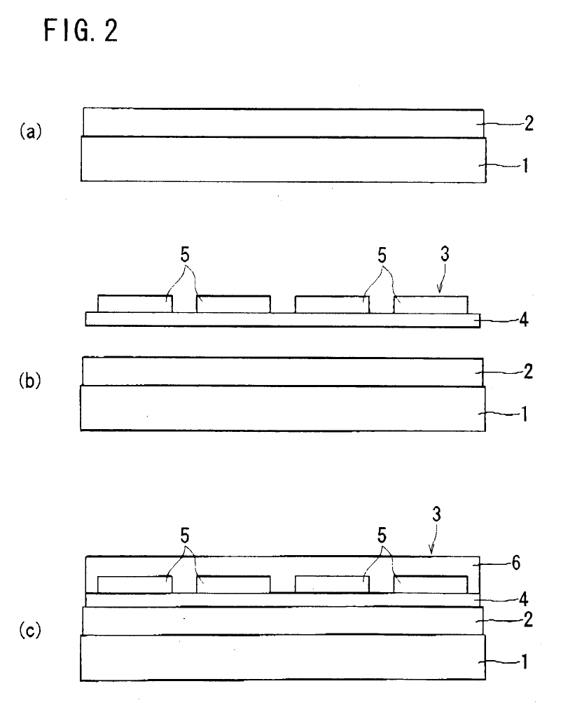

FIG. 1 is a drawing that shows processes in accordance with the manufacturing method of a temperature-controlling plate of the present invention, and FIG. 2 is a side view showing the manufacturing method.

First, in the first step S1, an adhesive layer 2 is formed on the surface of a heat-conducting plate 1 (see FIG. 2(a)). The heat-conducting plate 1 is formed by a high-temperature conductive material, for example, aluminum. The adhesive layer 2 is formed through respective processes, such as an application of a liquid resin material, a drying process and a curing process thereof. In the present embodiment, thermosetting liquid polyimide (trade name: Upifine LT) is used as the liquid resin material. In other words, after the liquid polyimide has been applied to the heat-conducting plate 1, this is heated to approximately 200° C., and dried. Thus, the solvent is removed from the liquid polyimide. Successively, this is heated to the range of approximately 200° C. to 350° C., preferably to approximately 300° C., at which a curing process is carried out. Consequently, the reaction progresses to form polyimide, while removing moisture. In this manner, an adhesive layer 2 having a thickness of approximately 10 μm is formed.

Next, in the second step S2, after the heat-conducting plate 1 and the film heater 3 have been positioned, they are superposed and placed. In other words, as illustrated in FIG. 2(b), the heat-conducting plate 1 and the film heater 3 are superposed so as to face each other, and placed with the adhesive layer 2 being interpolated in between. In this case, the film heater 3 is formed by subjecting a metal film thermally press-bonded to an insulation film 4 to an etching process so as to pattern the heater circuit 5 serving as the heat absorbing and radiating section. In the present embodiment, polyimide film is used as the insulation film 4 and stainless foil (trade name: Upicel VT) is used as the metal film. Here, the thickness of the polyimide film is approximately 10 μm, and the thickness of the heater circuit 5 is approximately 40 μm. Then, the film heater 3 is superposed on the heat-conducting plate 1, and placed, so as to allow its surface on the side opposite to the formation face of the heater circuit 5 to face the adhesive layer 2.

Successively, in the third step S3, the heat-conducting plate 1 and the film heater 3 are heated under a pressure by an autoclave process to be bonded to each other. The heating temperature is set to approximately 350 ° C., and the pressure is approximately 20 kg/cm².

Lastly, at the fourth step S4, the Insulation layer 6 is formed in a manner so as to cover the heater circuit 5; thus, a coating process is carried out. In the same manner as the adhesive layer 2, the insulation layer 6 is formed through respective processes, such as an application of a liquid resin material, a drying process and a curing process thereof. In other words, after the liquid polyimide (trade name: Upifine LT) has been applied to the insulation film 4 in a manner so as to cover the heater circuit 5, this is heated to approximately 200° C., and dried. Successively, this is heated to the range of approximately 200° C. to 350° C., preferably to approximately 300° C., at which a curing process is carried out. In this manner, the insulation layer 6 is formed, thereby completing a coating process. Here, the thickness of the insulation layer is set to be greater than 40 μm because the insulation layer 5 needs to cover the heater circuit 5 having a thickness of 40 μm.

As described above a temperature-controlling plate is produced through the above-mentioned four processes S1 to S4. In this temperature-controlling plate, the adhesive layer 2, formed by drying and curing the liquid polyimide, is used, it is possible to improve the adhesive state between the adhesive layer 2 and the heat-conducting plate 1, as compared with a case in which a sheet-shaped adhesive agent is used. Moreover, since the adhesive layer 2 and the insulation film 4 of the film heater 3 have physical properties similar to each other, the adhesive state of the adhesive layer 2 and the insulation film 4 is superior. Therefore, it is possible to positively bond the heat-conducting plate 1 and the film heater 3 to each other with sufficient strength.

Moreover, when the adhesive layer 2 is formed on the film heater 3 side, the film heater 3 is susceptible to wrinkles and warping at the time of drying and curing; however, in the present embodiment, since the adhesive layer 2 is formed on the surface of the heat-conducting platel, it is possible to manufacture a flat temperature-controlling plate without causing any wrinkles or warping in the film heater 3.

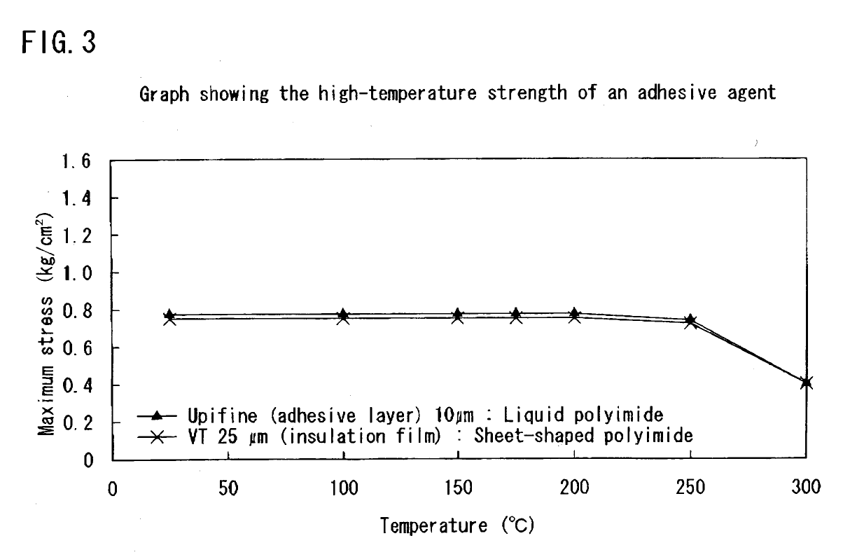

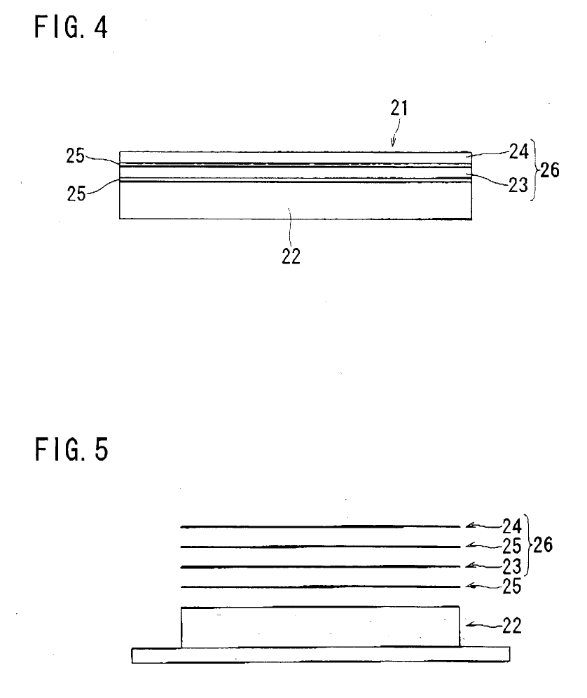

Furthermore, the adhesive layer 2 composed of liquid polyimide makes it possible to provide high-temperature strength similar to that of sheet-shaped polyimide even if the adhesive layer 2 is thin. FIG. 3 is a graph that shows the high-temperature strength of the adhesive agent. The adhesive layer constituted by sheet-shaped polyimide having a thickness of 25 μm and liquid polyimide of 10 μm exhibits virtually constant strength from normal temperature to approximately 250 ° C., and gradually decreases in its strength at temperatures of not less than 250° C. This shows that the high-temperature strength of the adhesive layer 2 is not adversely affected by the thinness of the adhesive layer 2. Furthermore, the adhesive layer 2 formed by one application of liquid polyimide has insulating and adhesive functions on the heater circuit 5 in a combined manner, thereby making it possible to form a thin layer.

Moreover, since the liquid polyimide is less expensive than the sheet-shaped polyimide (sheet-shaped adhesive agent), it is possible to manufacture a temperature-controlling plate at low costs. The application of liquid polyimide makes it possible to form an adhesive layer 2 thinner than that of the sheet-shaped adhesive material, thereby making the temperature-controlling plate thinner. Furthermore, since the thinness of the adhesive layer 2 makes it possible to improve the thermal conductivity correspondingly, it is possible to improve the performances of the temperature-controlling plate. Since the heater circuit 5 of the film heater 3 is covered with the insulation layer 6, it is possible to protect the heater circuit 5 and also to uniformly conduct heat. Moreover, in the case when the surface of the heater is coated with a cover sheet through a sheet-shaped adhesive agent, as in the case of the conventional method, the heater is susceptible to wrinkles and warping at the time of adhesion; however, the above-mentioned coating process in which the liquid resin is applied, dried and set makes it possible to eliminate such problems.

The above-mentioned description has discussed the specific embodiment of the manufacturing method of a temperature-controlling plate of the present invention; however, the manufacturing method of the temperature-controlling plate of the present invention is not intended to be limited by the above-mentioned embodiment, and various modifications thereof may be adopted. For example, in addition to the construction of the temperature-controlling plate shown in FIG. 2, the present invention may be applied to the following constructions. In the first construction, after liquid polyimide has been applied to the surface of the heat-conducting plate 1, dried and cured thereon to form an adhesive layer 2, liquid polyimide is again applied, dried and cured thereon to form another adhesive layer 2, and with the heater circuit 5 of the film heater 3 facing down (in a state opposite to the state of FIG. 2), the heater circuit 5 is allowed to contact the adhesive layer 2, and this is subjected to heating and pressure-applying processes (autoclave process) so that the two members are bonded to each other to form a temperature-controlling plate. In the second construction, after liquid polyimide has been applied to the surface of the heat-conducting plate 1, dried and cured thereon to form an adhesive layer 2, liquid polyimide is again applied thereon, and with the heater circuit 5 of the film heater 3 facing down (in a state opposite to the state of FIG. 2), the heater circuit 5 is allowed to contact the adhesive layer 2, and this is subjected to heating and pressure-applying processes (autoclave process) so that the liquid polyimide is dried and cured and the two members are bonded to each other to form a temperature-controlling plate.

Moreover, in the above-mentioned embodiments, liquid polyimide is used as the liquid resin material; however, the liquid resin material is not intended to be limited by this, and for example, another kind of liquid such as a polyamic acid solution may be used.

### REFERENCE NUMERALS

1. heat-conducting plate

2. adhesive layer

3. film heater

4. insulation film

5. heater circuit

6. insulation layer

What is claimed is:

1. A manufacturing method of a temperature-controlling plate, which-has an arrangement in which a film heater (3) constituted by a heat absorbing and radiating section (5) formed on a surface of a resin film (4) is bonded to a surface of a heat conducting plate (1) having a plate shape, comprising the steps of: forming an adhesive layer (2) by drying and setting liquid resin that has been applied to the surface of said heat conducting plate (1); placing said film heater (3) and the heat-conducting plate (1) so as to be aligned face to face with each other with the adhesive layer (2) interpolated in between; and heating this to a predetermined temperature while applying a predetermined pressure to this so as to bond said film heater (3) to the heat-conducting plate (1).

2. The manufacturing method of a temperature-controlling plate according to claim 1, wherein: the heat absorbing and radiating section (5) of said film heater (3) is formed on the side opposite to the adhesive face of said heat-conducting plate (1) so that the liquid resin is applied, dried and set in a manner so as to coat the heat absorbing and radiating section (5).

3. The manufacturing method of a temperature-controlling plate according to claim 1 or claim 2, wherein: said resin film (4) of said film heater (3) is a polyimide film, said heat-conducting plate (1) is aluminum, and said liquid resin is liquid polyimide.
